(19) United States
(12) Patent Application Publication
(10) Pub. No.: US 2013/0308331 A1
(43) Pub. Date: Nov. 21, 2013

(54) ANTI-GLARE LIGHT SOURCE

(71) Applicants: Zhi-Ting Ye, Miaoli County (TW); Ming-Chuan Lin, Taichung City (TW); Chih-Jung Teng, Taichung City (TW); Ming-Sin Jian, Taichung City (TW)

(72) Inventors: Zhi-Ting Ye, Miaoli County (TW); Ming-Chuan Lin, Taichung City (TW); Chih-Jung Teng, Taichung City (TW); Ming-Sin Jian, Taichung City (TW)

(73) Assignees: WINTEK CORPORATION, Taichung City (TW); DONGGUAN MASSTOP LIQUID CRYSTAL DISPLAY CO., LTD., Guangdong Province (CN)

(21) Appl. No.: 13/547,058

(22) Filed: Jul. 12, 2012

(30) Foreign Application Priority Data
May 21, 2012 (TW) 101117991

(51) Int. Cl. G02B 6/00; F21V 11/00

(52) U.S. Cl. 362/551; 362/217.02

(57) ABSTRACT

An anti-glare light source includes a linear light source and a light-modulation element. The linear light source is suitable for providing light, and the light-modulation element is disposed on a propagating path of the light. The light-modulation element includes a plurality of parallel bar-shaped prisms. The bar-shaped prisms are arranged along an extension direction of the linear light source. An extension direction of each of the bar-shaped prisms is substantially perpendicular to the extension direction of the linear light source so as to converge the distribution of the light along the extension direction of the linear light source.

### CROSS-REFERENCE TO RELATED APPLICATION

This application claims the priority benefit of Taiwan application serial no. 101117991, filed on May 21, 2012. The entirety of the above-mentioned patent application is hereby incorporated by reference herein and made a part of this specification.

### BACKGROUND

1. Technical Field

The technical field relates to a light source. More particularly, the technical field relates to an anti-glare light source.

2. Related Art

A light-emitting diode (LED) is a semiconductor device, and a light-emitting chip of the LED is mainly made of a compound that contains group III-V chemical elements, such as gallium phosphide (GaP), gallium arsenid (GaAs), and so forth. According to the light emission principle of the LED, electric energy is converted into light. In particular, an electric current is applied to the semiconductor compound, such that electrons and holes in the semiconductor compound of the LED are combined to release excessive energy in form of light. Since the LED does not emit light through thermal emission or electric discharge, the service life of the LED often reaches or even exceeds 100,000 hours. Moreover, the LED has the advantages of fast response speed, compact size, low power consumption, low pollution, high reliability, capability for mass production, etc. Therefore, the application of LED is fairly extensive, e.g., mega-size outdoor display boards, traffic lights, cell phones, light sources of scanners and facsimile machine, illumination devices, and so forth.

LED light bars, for instance, frequently serve as illumination devices, and each LED light bar may include a printed circuit board (PCB) and a plurality of LED packages linearly arranged on the PCB. Given that some of the LED packages on the PCB cannot emit light in a normal manner, the resultant partial dark zones may disable the LED light bar from providing uniform linear light. At this time, the entire LED light bar has to be replaced; hence, the life span of the existing LED light bar is relatively short, and the maintenance costs of the existing light bar are significant.

In view of the design defects of the LED light bars, a conventional linear light source that includes a light guiding rod and LEDs packaged at an end of the light guiding rod has been proposed. Here, the light guiding rod serves to guide light emitted from the LED packages, so as to supply uniform light. If some of the LED packages may not emit light in a normal manner, the light emitted from the light guiding bar with low brightness can still be uniform. Besides, during maintenance of said linear light source, not the entire light guiding rod but the dysfunctional LED packages need be replaced, and thus the maintenance costs are low.

As described above, the light provided by the LED packages is dispersed to a certain degree, and therefore a user is apt to experience glare if the dispersion degree of the light provided by the LED packages can no longer be controlled. For instance, the light guiding rod is made by extrusion, and thus the light distribution along the extension direction of the light guiding rod is rather disperse, which likely causes unwanted glare. Accordingly, how to lessen the dispersion degree of the linear light source and further resolve the glare issue of the linear light source has become an essential topic to researchers.

### SUMMARY

The disclosure is directed to an anti-glare light source that has a light-modulation element for reducing glare of the light source.

In one of exemplary embodiments, an anti-glare light source that includes a linear light source and a light-modulation element is provided. The linear light source is suitable for providing light, and the light-modulation element is disposed on a propagating path of the light. The light-modulation element includes a plurality of parallel bar-shaped prisms. The bar-shaped prisms are arranged along an extension direction of the linear light source. An extension direction of each of the bar-shaped prisms is substantially perpendicular to the extension direction of the linear light source so as to converge the distribution of the light along the extension direction of the linear light source.

In one of exemplary embodiments, the linear light source includes a light guiding rod and at least one light source that is disposed at at least one end of the light guiding rod.

In one of exemplary embodiments, a top corner of each of the bar-shaped prisms ranges from about 140 degrees to about 150 degrees.

In one of exemplary embodiments, the light-modulation element further includes a substrate, and the bar-shaped prisms are arranged on the substrate. For instance, the substrate and the bar-shaped prisms are integrally formed.

In one of exemplary embodiments, an anti-glare light source that includes a linear light source and a light-modulation element is further provided. The linear light source is suitable for providing light, and the light-modulation element is disposed on a propagating path of the light. The light-modulation element includes a plurality of parallel ring-shaped prisms arranged along an extension direction of the linear light source, and each of the ring-shaped prisms surrounds the linear light source so as to converge distribution of the light along the extension direction of the linear light source.

In one of exemplary embodiments, a top corner of each of the ring-shaped prisms ranges from about 140 degrees to about 150 degrees.

In one of exemplary embodiments, the light-modulation element further includes a tube, the linear light source is disposed in the tube, and the ring-shaped prisms are arranged on an outer surface of the tube. For instance, the tube and the ring-shaped prisms are integrally formed.

In the disclosure, the light-modulation element that includes the bar-shaped prisms or the ring-shaped prisms allows the distribution of light to be converged along the extension direction of the linear light source, and thereby glare of the light source may be reduced in the disclosure.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view illustrating an anti-glare light source according to a first embodiment of the disclosure.

FIG. 2 is a schematic view illustrating an anti-glare light source according to a second embodiment of the disclosure.

FIG. 3A illustrates intensity distribution of a linear light source.

FIG. 3B illustrates intensity distribution of the anti-glare light source 100 shown in FIG. 1.

FIG. 3C illustrates intensity distribution of the anti-glare light source 200 shown in FIG. 2.

### DETAILED DESCRIPTION OF DISCLOSED EMBODIMENTS

### First Embodiment

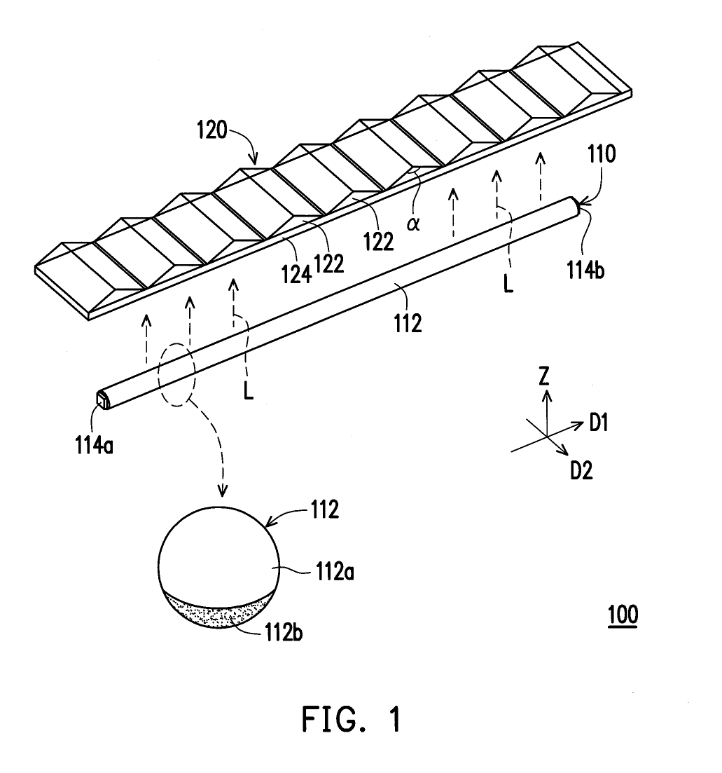

FIG. 1 is a schematic view illustrating an anti-glare light source according to a first embodiment of the disclosure. With reference to FIG. 1, the anti-glare light source 100 described in the present embodiment includes a linear light source 110 and a light-modulation element 120. The linear light source 110 is suitable for providing light L, and the light-modulation element 120 is disposed on a propagating path of the light L. The light-modulation element 120 includes a plurality of parallel bar-shaped prisms 122. The bar-shaped prisms 122 are arranged along an extension direction D1 of the linear light source 110. An extension direction D2 of each of the bar-shaped prisms 122 is substantially perpendicular to the extension direction D1 of the linear light source 110 so as to converge the distribution of the light L along the extension direction D1 of the linear light source 110. Namely, the bar-shaped prisms 122 allow the distribution of light L to be converged on a plane where the extension direction D1 and an z axis are located.

As shown in FIG. 1, the linear light source 110 described in the present embodiment includes a light guiding rod 112 and two light sources 114a and 114b. The two light sources 114a and 114b are respectively arranged at two ends of the light guiding rod 112 (i.e., the double-sided light incident design). According to another feasible embodiment of the disclosure, the linear light source may also include one single light source that is arranged at one end of the light guiding rod (i.e., the single-sided light incident design). The configuration of the linear light source 110 is not limited in the disclosure, and people having ordinary skill in the pertinent art may employ other types of linear light sources 110.

The lower-left portion of FIG. 1 is an enlarged cross-sectional view schematically illustrating the light guiding rod 112 on the z-D2 plane. According the present embodiment, the light guiding rod 112 is formed by extrusion, for instance. In detail, the light guiding rod 112 may be made by extruding transparent materials with the same base but slightly different transmittance according to the present embodiment. The light guiding rod 112 described herein includes a light guiding portion 112a and a reflection portion 112b. For instance, in this embodiment, the light guiding rod 112 may be made by extruding acrylic materials with and without doped scattered particles. After the extrusion process is performed, the light guiding portion 112a is made of the acrylic material without doped scattered particles, so as to effectively guide the light L; the reflective portion 112b is made of the acrylic material with the doped scattered particles, so as to reflect or scatter the light L. Thereby, the light L may be emitted along a specific direction.

As shown in FIG. 1, each of the bar-shaped prisms 122 has a top corner a that exemplarily ranges from about 140 degrees to about 150, such that the distribution of light L may be converged on the plane where the extension direction D1 and the z axis are located.

In addition to the bar-shaped prisms 122, the light-modulation element 120 may further include a substrate 124, and the bar-shaped prisms 122 are arranged on the substrate 124. Fabrication of the bar-shaped prisms 122 on the substrate 124 is conducive to manufacture of the light-modulation element 120. In the present embodiment, the substrate 124 and the bar-shaped prisms 122 are formed by an injection molding process, for instance. That is, the substrate 124 and the bar-shaped prisms 122 are integrally formed. Certainly, the material of and the way to form the substrate 124 and the bar-shaped prisms 122 are not limited in the disclosure, and people having ordinary skill in the pertinent art may change the material of and the way to form the substrate 124 and the bar-shaped prisms 122 (e.g., extrusion) based on actual design demands.

In addition, the substrate 124 described herein not only can be a flat board but also can be a bent substrate; the structural profile of the substrate 124 is not limited in the disclosure.

### Second Embodiment

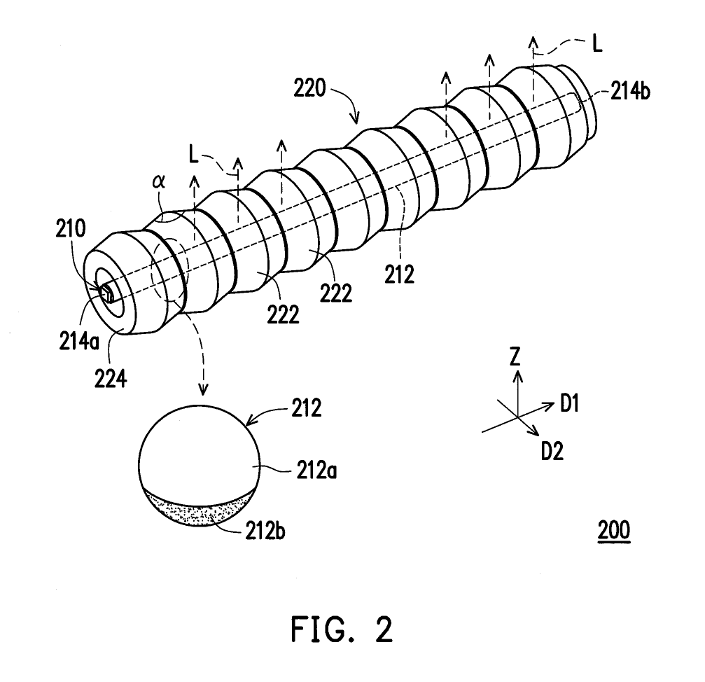

FIG. 2 is a schematic view illustrating an anti-glare light source according to a second embodiment of the disclosure. With reference to FIG. 2, the anti-glare light source 200 described in the present embodiment includes a linear light source 210 and a light-modulation element 220. The linear light source 210 is suitable for providing light L, and the light-modulation element 220 is disposed on a propagating path of the light L. The light-modulation element 220 includes a plurality of parallel ring-shaped prisms 222 arranged along an extension direction D1 of the linear light source 210, and each of the ring-shaped prisms 222 surrounds the linear light source 210 so as to converge distribution of the light L along the extension direction D1 of the linear light source 210.

As shown in FIG. 2, the linear light source 210 described in the present embodiment includes a light guiding rod 212 and two light sources 214a and 214b. The two light sources 214a and 214b are respectively arranged at two ends of the light guiding rod 212 (i.e., the double-sided light incident design). According to another feasible embodiment of the disclosure, the linear light source may also include one single light source that is arranged at one end of the light guiding rod (i.e., the single-sided light incident design). The configuration of the linear light source 210 is not limited in the disclosure, and people having ordinary skill in the pertinent art may employ other types of linear light sources 210.

The lower-left portion of FIG. 2 is an enlarged cross-sectional view schematically illustrating the light guiding rod 212 on the z-D2 plane. According the present embodiment, the light guiding rod 212 is formed by extrusion, for instance. In detail, the light guiding rod 212 may be made by extruding transparent materials with the same base but slightly different transmittance according to the present embodiment. The light guiding rod 212 described herein includes a light guiding portion 212a and a reflection portion 212b. For instance, in this embodiment, the light guiding rod 212 may be made by extruding acrylic materials with and without doped scattered particles. After the extrusion process is performed, the light guiding portion 212a is made of the acrylic material without the doped scattered particles, so as to effectively guide the light L; the reflective portion 212b is made of the acrylic material with the doped scattered particles, so as to reflect or scatter the light L. Thereby, the light L may be emitted along a specific direction.

As shown in FIG. 2, each of the ring-shaped prisms 222 has a top corner a that exemplarily ranges from about 140 degrees to about 150, such that the distribution of light L may be converged along the extension direction D1 of the linear light source 210.

In addition to the ring-shaped prisms 222, the light-modulation element 220 may further include a tube 224, the linear light source 210 is disposed in the tube 224, and the ring-shaped prisms 222 are arranged on an outer surface of the tube 224. Specifically, the light guiding rod 212 of the linear light source 210 is telescoped into the tube 224, for instance. Namely, the tube 224 is disposed around the light guiding rod 212 of the linear light source 210.

For instance, the tube 224 and the ring-shaped prisms 222 are integrally formed. In the present embodiment, the substrate 224 and the ring-shaped prisms 222 are formed by an injection molding process, for instance. That is, the substrate 224 and the ring-shaped prisms 222 are integrally formed. Certainly, the material of and the way to form the substrate 224 and the ring-shaped prisms 222 are not limited in the disclosure, and people having ordinary skill in the pertinent art may change the material of and the way to form the substrate 224 and the ring-shaped prisms 222 based on actual design demands.

### EXPERIMENTAL EXAMPLE

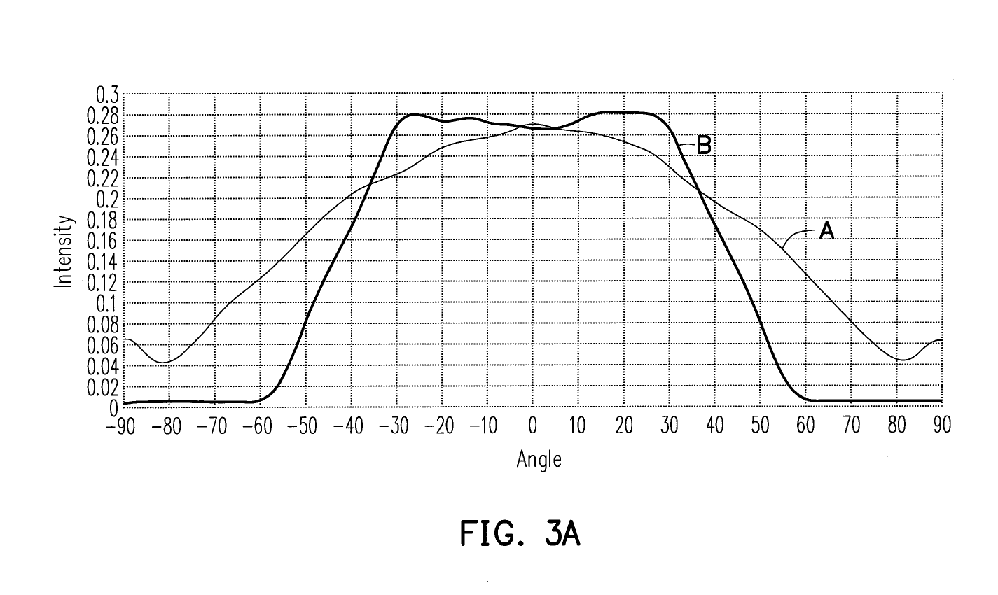

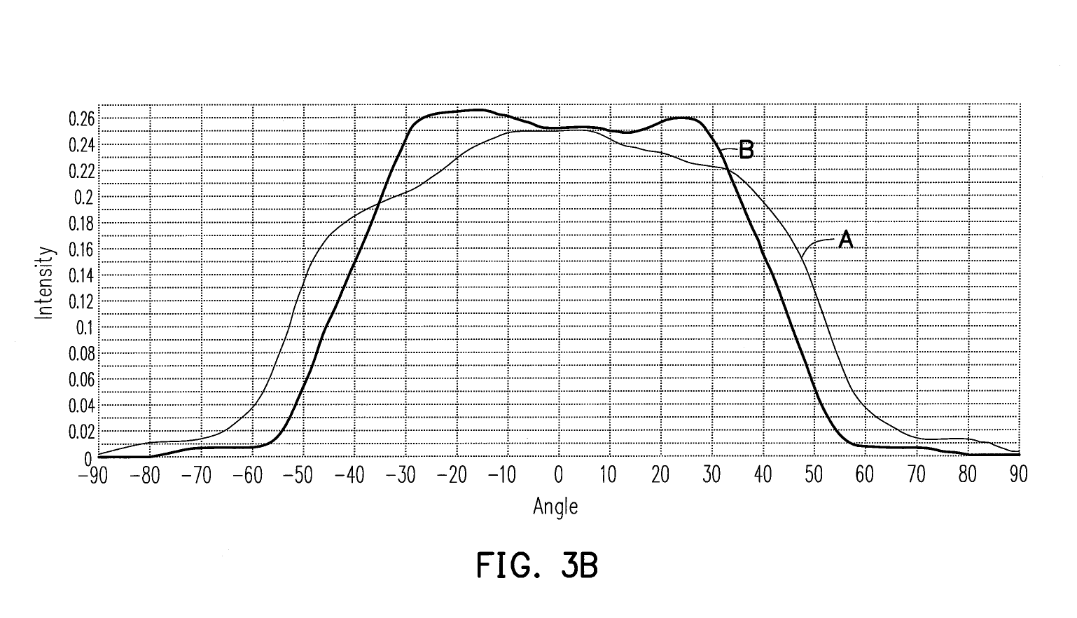

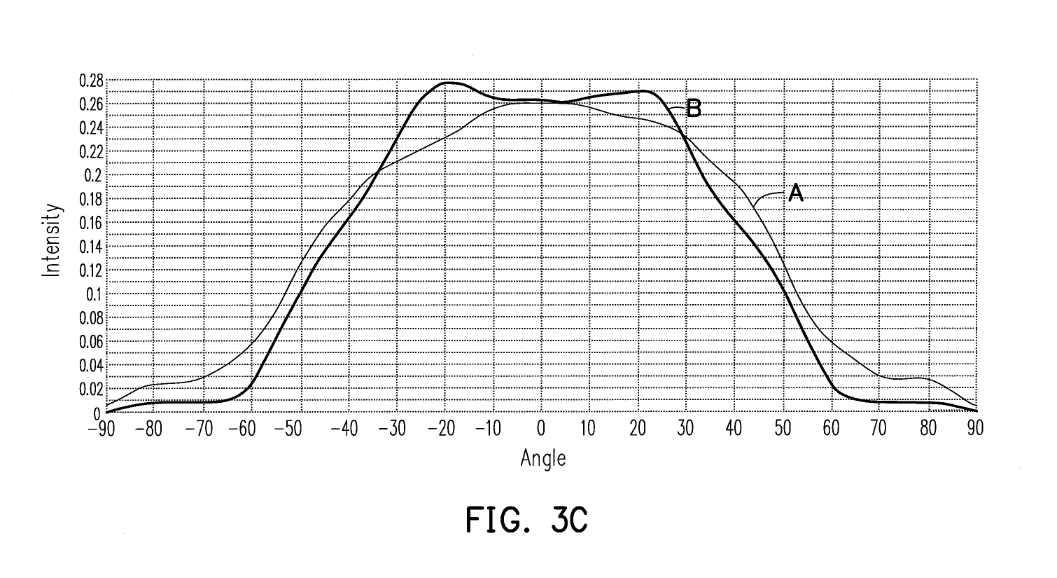

FIG. 3A illustrates intensity distribution of a linear light source. FIG. 3B illustrates intensity distribution of the anti-glare light source 100 shown in FIG. 1. FIG. 3B illustrates intensity distribution of the anti-glare light source 200 shown in FIG. 2. With reference to FIG. 3A to FIG. 3C, the curve A indicates the distribution of light on the plane where the extension direction D1 and the z axis are located, and the curve B indicates the distribution of light on the plane where the extension direction D2 and the z axis are located. It can be learned from the curve A of FIG. 3A that the distribution of light is relatively dispersed on the plane where the extension direction D1 and the z axis are located, given that no light-modulation element is applied. Therefore, glare is likely to occur. By contrast, as shown by the curve A of FIG. 3B, the distribution of light is relatively converged on the plane where the extension direction D1 and the z axis are located, given that the light-modulation element 120 described in the first embodiment is applied. Therefore, glare is not apt to occur. Similarly, as shown by the curve A of FIG. 3C, the distribution of light is relatively converged on the plane where the extension direction D1 and the z axis are located, given that the light-modulation element 220 described in the second embodiment is applied. Therefore, glare is not apt to occur.

In the disclosure, the light-modulation element that includes the bar-shaped prisms or the ring-shaped prisms allows the distribution of light to be converged along the extension direction of the linear light source, and thereby glare of the light source may be reduced in the disclosure.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An anti-glare light source comprising:
a linear light source suitable for providing light; and
a light-modulation element disposed on a propagating path of the light, the light-modulation element including a plurality of parallel bar-shaped prisms, wherein the bar-shaped prisms are arranged along an extension direction of the linear light source, and an extension direction of each of the bar-shaped prisms is substantially perpendicular to the extension direction of the linear light source so as to converge distribution of the light along the extension direction of the linear light source.

2. The anti-glare light source as recited in claim 1, wherein the linear light source comprises:
a light guiding rod; and
at least one light source disposed at at least one end of the light guiding rod.

3. The anti-glare light source as recited in claim 1, wherein a top corner of each of the bar-shaped prisms ranges from about 140 degrees to about 150 degrees.

4. The anti-glare light source as recited in claim 1, wherein the light-modulation element further comprises a substrate, and the bar-shaped prisms are arranged on the substrate.

5. The anti-glare light source as recited in claim 4, wherein the substrate and the bar-shaped prisms are integrally formed.

6. An anti-glare light source comprising:
a linear light source suitable for providing light; and
a light-modulation element disposed on a propagating path of the light, the light-modulation element including a plurality of parallel ring-shaped prisms, wherein the ring-shaped prisms are arranged along an extension direction of the linear light source, and each of the ring-shaped prisms surrounds the linear light source so as to converge distribution of the light along the extension direction of the linear light source.

7. The anti-glare light source as recited in claim 6, wherein the linear light source comprises:
a light guiding rod; and
at least one light source disposed at at least one end of the light guiding rod.

8. The anti-glare light source as recited in claim 6, wherein a top corner of each of the ring-shaped prisms ranges from about 140 degrees to about 150 degrees.

9. The anti-glare light source as recited in claim 6, wherein the light-modulation element further comprises a tube, the linear light source is disposed in the tube, and the ring-shaped prisms are arranged on an outer surface of the tube.

10. The anti-glare light source as recited in claim 9, wherein the tube and the ring-shaped prisms are integrally formed.
